(19) United States
(12) Patent Application Publication
(10) Pub. No.: US 2014/0297334 A1
(43) Pub. Date: Oct. 2, 2014

(54) SYSTEM AND METHOD FOR MACRO LEVEL STRATEGIC PLANNING

(71) Applicants: Linda F. Hibbert, Chalfont, PA (US); Trammell Antonio Brown, Conshohocken, PA (US); Jessica L. Conley, Harleysville, PA (US); Edward A. Smeal, Willow Grove, PA (US)

(72) Inventors: Linda F. Hibbert, Chalfont, PA (US); Trammell Antonio Brown, Conshohocken, PA (US); Jessica L. Conley, Harleysville, PA (US); Edward A. Smeal, Willow Grove, PA (US)

(21) Appl. No.: 13/855,093

(22) Filed: Apr. 2, 2013

(51) Int. Cl. G06Q 40/08

(52) U.S. Cl. CPC G06Q 40/08
USPC 705/4

(57) ABSTRACT

According to some embodiments, an indication of a selected metric to be predicted, such as an insurance related metric, may be received. A system may analyze historical information to automatically determine a set of relevant underlying factors for that selected metric and a predictive model may be created. One or more future scenarios associated with an impact on relevant underlying factors may be defined, and a series of predicted impacted future values may be identified for those impacted relevant underlying factors. A series of impacted future values may then be predicted for the selected metric based on the predicted impacted future values and the predictive model.

### BACKGROUND

An enterprise may be interested in accurately predicting future values for one or more metrics. For example, a company might want to predict a product's future sales volume so that appropriate manufacturing resources, sales personnel, etc., may be obtained for that product. Moreover, an enterprise may want to strategically plan for the future by predicting quantifiable impacts of macro-level environment based scenarios and associated business results. For example, a company may adjust strategic plans when a new product or competitor enters a market. As another example, a new regulation or statutory change might be implemented by a governmental agency. Estimating these types of business impacts, however, can be a time-consuming, expensive, and error-prone process, especially when a substantial number of metrics, underlying factors (e.g., underlying business parameters that can cause changes to the metric being considered), and/or potential scenarios are being considered.

It would therefore be desirable to provide automatic and accurate systems and methods to facilitate an understanding of a future scenario's impact on one or more metrics.

### SUMMARY OF THE INVENTION

According to some embodiments, systems, methods, apparatus, computer program code and means may be provided to facilitate an understanding of a future scenario's impact on a selected metric. In some embodiments, an indication of a selected insurance related metric to be predicted may be received. A system may analyze historical information for a set of potential underlying factors to automatically determine a set of relevant underlying factors associated with the selected insurance related metric. A predictive model may be created based on relationships between values of the set of relevant underlying factors and values of the selected insurance related metric. In addition, a series of predicted future values may be identified for each relevant underlying factor, and a series of future values for the selected insurance related metric may be predicted based on the series of predicted future values for each relevant underlying factor and the predictive model. A future scenario associated with an impact on at least one of the relevant underlying factors may be defined, and a series of predicted impacted future values may be identified for each impacted relevant underlying factor associated with the future scenario. A series of impacted future values may then be predicted for the selected insurance related metric based on the series of predicted impacted future values for each impacted relevant underlying factor and the predictive model. According to some embodiments, an indication of the series of impacted future values for the selected insurance related metric may be transmitted.

Some embodiments provide: means for automatically analyzing, by a modeling engine executed by a computer processor, historical information for a set of potential underlying factors to determine a set of relevant underlying factors associated with insurance plan enrollment; means for creating, by the modeling engine, a predictive model based on relationships between values of the set of relevant underlying factors and insurance plan enrollment values; means for identifying a series of predicted future values for each relevant underlying factor; means for defining a future scenario associated with an impact on at least one of the relevant underlying factors; means for identifying a series of predicted impacted future values for each impacted relevant underlying factor associated with the future scenario; means for predicting a series of impacted future insurance plan enrollment values based on the series of predicted impacted future values for each impacted relevant underlying factor and the predictive model; and means for transmitting an indication of the series of impacted future insurance plan enrollment values.

A technical effect of some embodiments of the invention is an improved and computerized method of understanding a future scenario's impact on a selected metric. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method according to some embodiments of the present invention.

FIG. 3 is an example of a work flow in accordance with some embodiments.

FIG. 4 is a more detailed block diagram of a system according to some embodiments of the present invention.

FIG. 5 is block diagram of a scenario analytics apparatus according to some embodiments of the present invention.

FIG. 6 is a tabular portion of a scenario impact database according to some embodiments.

FIG. 7 is an illustration associated with a predictive model according to some embodiments.

FIG. 8 is an illustration associated with predicted future values for a selected metric in accordance with some embodiments.

FIG. 9 is an illustration associated with a scenario's impact according to some embodiments.

FIG. 10 illustrates a display in accordance with some embodiments described herein.

### DESCRIPTION

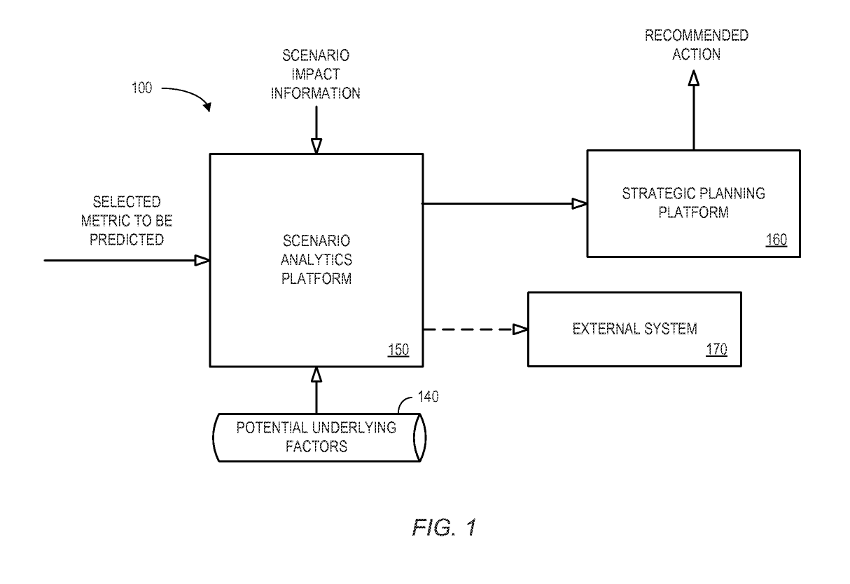

An enterprise may be interested in accurately predicting future values for one or more business parameters or “metrics.” For example, an insurance company might want to predict future enrollment rates for a particular type of insurance program so that appropriate advertising resources, sales personnel, etc., may be obtained for that program. Moreover, the enterprise might want to strategically plan for the future by predicting the impacts different scenarios could have on various metrics. To facilitate such goals, FIG. 1 is block diagram of a system 100 according to some embodiments of the present invention. In particular, the system 100 includes a scenario analytics platform 150 that receives an indication of a selected metric to be predicted. The scenario analytics platform 150 might be, for example, associated with a Personal Computer (“PC”), laptop computer, an enterprise server, a server farm, and/or a database or similar storage devices. The scenario analytics platform 150 may, according to some embodiments, be associated with an organization or an insurance provider.

According to some embodiments, an “automated” scenario analytics platform 150 may facilitate an understanding of a future scenario's impact on a selected metric. As used herein, the term “automated” may refer to, for example, actions that can be performed with little or no human intervention.

As used herein, devices, including those associated with the scenario analytics platform 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The scenario analytics platform 150 may also access a database associated with a number of potential underlying factors 140. The database associated with potential underlying factors 140 might be operated, for example, by a government agency or a news service. The database associated with potential underlying factors 140 may be locally stored or reside remote from the scenario analytics platform 150. As will be described further herein, the database associated with potential underlying factors 140 may be used by the scenario analytics platform 150 to help improve predictions and facilitate an understanding of a future scenario's impact on or more metrics.

Although a single scenario analytics platform 150 is shown in FIG. 1, any number of such devices may be included. Moreover, various devices described herein might be combined according to embodiments of the present invention. For example, in some embodiments, the scenario analytics platform 150 and the database associated with potential underlying factors 140 might be co-located and/or may comprise a single apparatus. According to some embodiments, the scenario analytics platform 150 receives scenario impact information (e.g., from a business analyst or from another device) and provides information to a strategic planning platform 160 (which might output one or more recommended actions in response to a scenario). Moreover, the scenario analytics platform 150 may automatically and directly output data to one or more external systems 170, such as report generators, email servers, workflow applications, etc.

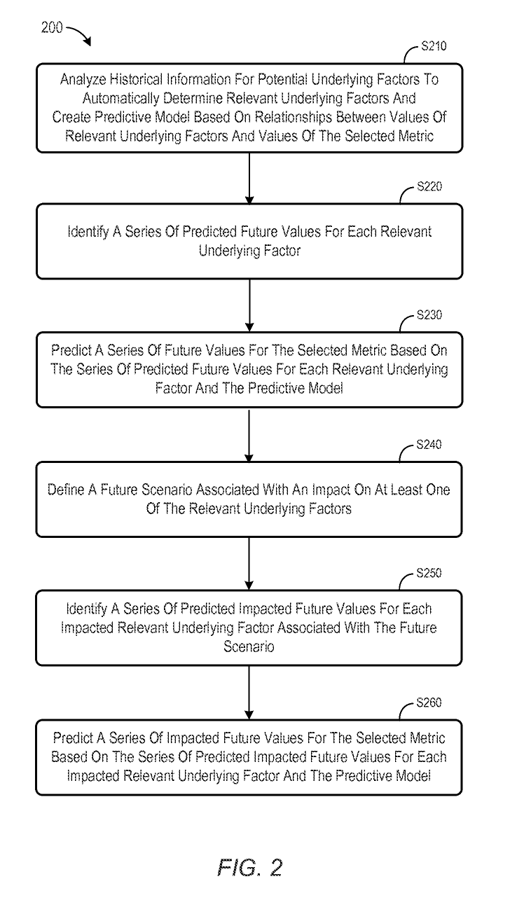

FIG. 2 illustrates a method that might be performed, for example, by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, historical information for a set of potential underlying factors may be analyzed to automatically determine a set of relevant underlying factors associated with a “selected metric.” According to some embodiments described herein, an indication of the selected metric might be received from a business analyst or from an external device. By way of examples only, a selected metric might be associated with sales, profit, prices, participation percentages, call center volume, a business result, market share, and/or insurance information (e.g., reflecting overall enrollment in an insurance program). Moreover, the potential underlying factors might be associated with population age information, gross domestic product, enrollment rates, market share, inflation, employment rates, and/or a macroeconomic trend.

Once the relevant factors are identified, a predictive “model” may be created at S210 based on relationships between values of the set of relevant underlying factors and values of the selected metric. As used herein, predictive models, in various implementations, may refer to one or more of statistical models, multi-variable regression models, neural networks, Bayesian networks (such as hidden Markov models), expert systems, decision trees, collections of decision trees, support vector machines, or other systems known in the art for addressing problems with large numbers of variables. Preferably, the predictive models may be trained on prior data and outcomes known to an enterprise, such as an insurance company. The specific data (underlying factors) and outcomes (selected metrics) analyzed vary depending on the desired functionality of the particular predictive model. The particular data parameters selected for analysis in the training process may be determined by using regression analysis and/or other statistical techniques known in the art for identifying relevant variables in multivariable systems. The parameters can be selected from any of the structured data parameters stored in the present system, and an application of weighting factors to various parameters may improve the predictive power of the model.

At S220, a series of predicted future values may be identified for each relevant underlying factor. The identification of predicted future values for each relevant underlying factor might be associated with, for example, a third party service, census data, governmental projections, and/or an underlying factor model (e.g., a predictive model that outputs estimated gross domestic product values for future years). At S230, a series of future values for the selected metric may be predicted based on the series of predicted future values for each relevant underlying factor and the predictive model.

At S240, a future scenario associated with an impact on at least one of the relevant underlying factors may be defined. The future scenario may associated with any event that might impact the selected metric such as, for example, a regulatory or statutory change, an enterprise entering a marketplace, an enterprise exiting a marketplace, and/or an introduction of a new product. At S250, a series of predicted impacted future values may be identified for each impacted relevant underlying factor associated with the future scenario. For example, if the future scenario was associated with a three year global recession that would begin in the year 2020, gross domestic product values for the years 2020, 2021, and 2022 might be reduced by a pre-determined amount or percentage.

At S260, a series of impacted future values may be predicted for the selected metric based on the series of predicted impacted future values for each impacted relevant underlying factor and the predictive model. That is, the impacted relevant underlying factor values may be fed through the predictive model to determine what impact the scenario will have on the selected metric. According to some embodiments, an indication of the series of impacted future values for the selected metric may be transmitted to a business analyst or to another device. According to some embodiments, the transmitted indication of the series of impacted future values is associated with a delta change associated with the scenario, a report, a spreadsheet application, and/or a strategic recommendation. In some cases, the system may further compare impacted future values for the selected metric value associated with a first future scenario with impacted future values for the selected metric value associated with a second future scenario.

Note that any of the embodiments described herein might be associated with a spreadsheet application (e.g., the EXCEL® spreadsheet application available from Microsoft®) and/or the SAS tool available from SAS, INC.® that provides an integrated environment for predictive and descriptive modeling, data mining, text analytics, forecasting, optimization, and simulation capabilities. Other tools that might be used for this process may include, for example, NICE Perform (for voice recording and text mining) and/or R (open source data mining software).

Frameworks described herein may comprise a tool and repeatable process that facilitate long term strategic planning by predicting quantifiable impacts of macro environment-based scenarios and associated business results. For example, an enterprise may: select a metric to predict, such as sales volumes; develop potential future scenarios and assumptions (e.g., competitor A goes out of business, a pending regulation goes into effect, or new a product erodes market share); and quantify the expected impact of the scenario to sales volume. Moreover, embodiments may provide flexibility to assess such impacts as individual scenarios as well as collective scenarios (accounting for situations when factors from different scenarios are related to one another).

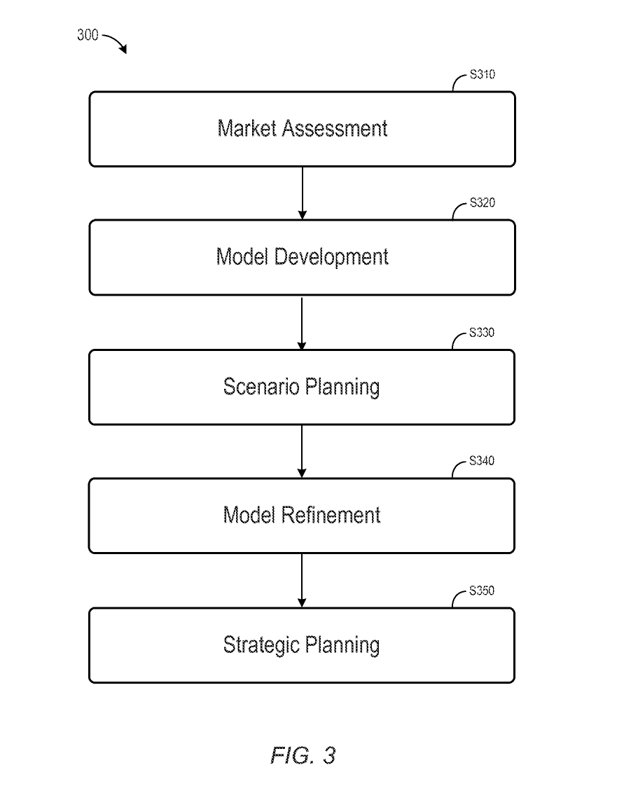

FIG. 3 is an example of a work flow 300 in accordance with some embodiments. At S310, a market assessment may be performed. The market assessment may, for example, be associated with the ongoing day-to-day activities of an enterprise, including staying apprised of the marketplace, a particular industry, and/or competitor trends. This perspective may help identify one or more specific metrics an enterprise would like to predict. By way of example, there might be substantial interest in macroeconomic trends as a result of a recession.

At S320, a model development process may be performed. Once the metric to predict has been selected, a statistical model may be built to determine appropriate projections. According to some embodiments, a combination of autoregressive integrated moving average and mixed regression modeling techniques may be used with a focus on a 10-year time horizon for projections.

In some cases, model development may require a significant amount of data preparation, gathering historical and projection data from internal sources (e.g., sales volumes, revenue, or customer demographics) and external sources (e.g., population demographics, macroeconomic indicators such as gross domestic product values, unemployment rates, or industry-level data), and incorporating the data into the modeling process. Note that such data points may be evaluated using an SAS modeling tool to identify a subset of data points (“relevant underlying factors”) that best predict the target metric. A customized, partially automated solution in SAS may be implemented to compare large volumes of potential models and rank order the models to determine an appropriate fit. The output may comprise a single statistical model that generates projections for the target metric over the next 10 years.

At S330, a scenario planning process may be performed. For example, business stakeholders may leverage market expertise to identify and prioritize potential scenarios based on key business-related events expected to occur in the future, such as regulatory or macroeconomic changes or competitor activity. The stakeholders may then develop key impact assumptions to be incorporated into the model. For example, if Scenario A is that a competitor leaves the market, the impact assumption might be that a company's market share will grow by 5% each year over the next 3 years.

At S340, model refinement may be performed. For example, once all scenarios and impact assumptions have defined, the scenario adjustments may be incorporated into the statistical model and new projections may be produced. Note that scenarios may be evaluated on an individual or collective basis. Since the tool and process may be partially automated, adjustments to the scenarios and impact assumptions may be performed relatively easily. In the event that a scenario requires data points not included in the original projection model, the model development step S320 may be re-initiated to develop a new model that incorporates all data points or factors required for the scenario.

At S350, strategic planning may be performed. For example, the outcome of the modeling refinement process S340 may provide insights about the impact of various scenarios to target metrics of potential changes in the marketplace. This knowledge may then incorporated by the enterprise into the ongoing strategic planning process.

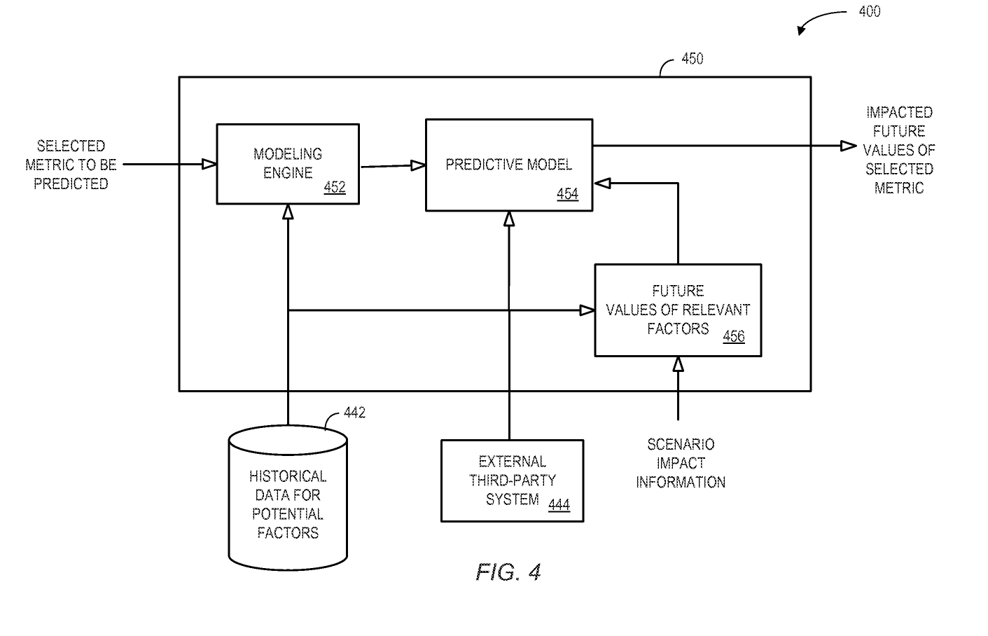

The steps described with respect to FIG. 3 may be performed by various systems and apparatus. For example, FIG. 4 is a more detailed block diagram of a system 400 according to some embodiments of the present invention. As before, a scenario analytics engine 450 may receive an indication of a selected metric to be predicted. In particular, a modeling engine 452 executing in the scenario analytics engine 450 may receive the selected metric along with historical data for potentially relevant factors 442 and information from an external third-party system 444 (e.g., associate with the U.S. Department of Labor). The modeling engine 452 may use this information to develop a predictive model 454 that will generate predictions of the selected metric. According to some embodiments, future values of the relevant underlying factors 456 may be determined based on the historical data for potentially relevant factors 442, information from an external third-party system 444, and scenario impact information may be used to adjust those future values. The adjusted future values of the relevant underlying factors 456 may be re-fed into the predictive model 454 and the impacted future values of the selected metric may be output from the scenario analytics platform 450 to help an enterprise strategically plan for the future.

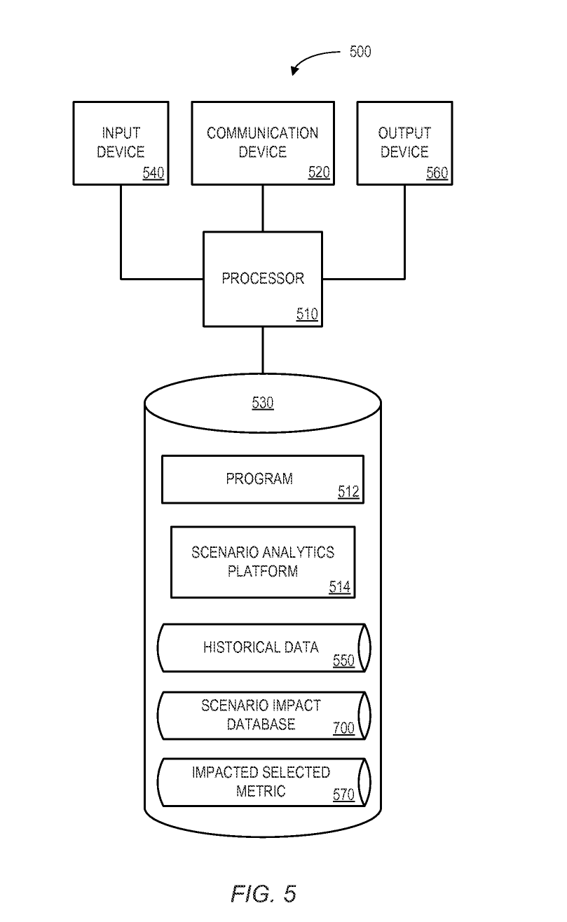

The embodiments described herein may be implemented using any number of different hardware configurations. For example, FIG. 5 illustrates a scenario analytics apparatus 500 that may be, for example, associated with either of the systems 100, 500 of FIG. 1 or 5, respectively. The scenario analytics apparatus 500 comprises a processor 510, such as one or more commercially available Central Processing Units (CPUs) in the form of one-chip microprocessors, coupled to a communication device 520 configured to communicate via a communication network (not shown in FIG. 5). The communication device 520 may be used to communicate, for example, with one or more remote devices or third-party data services. The scenario analytics apparatus 500 further includes an input device 540 (e.g., a mouse and/or keyboard to enter scenario information) and an output device 550 (e.g., a computer monitor to display predictions and/or recommendations to an operator or administrator).

The processor 510 also communicates with a storage device 530. The storage device 530 may comprise any appropriate information storage device, including combinations of magnetic storage devices (e.g., a hard disk drive), optical storage devices, mobile telephones, vehicle computers, and/or semiconductor memory devices. The storage device 530 stores a program 512 and/or a customer analytics tool 514 (e.g., an interactive application) for controlling the processor 510. The processor 510 performs instructions of the programs 512, 514, and thereby operates in accordance with any of the embodiments described herein. For example, the processor 510 may analyze historical information for a set of potential underlying factors to determine a set of relevant underlying factors associated with insurance plan enrollment. The processor 510 may also create a predictive model based on relationships between values of the set of relevant underlying factors and insurance plan enrollment values. The processor 510 may then identify a series of predicted future values for each relevant underlying factor and define a future scenario associated with an impact on at least one of the relevant underlying factors. A series of predicted impacted future values may be identified by the processor 510 for each impacted relevant underlying factor associated with the future scenario. The processor 510 may then predict a series of impacted future insurance plan enrollment values based on the series of predicted impacted future values for each impacted relevant underlying factor and the predictive model. According to some embodiments, the processor 510 transmits an indication of the series of impacted future insurance plan enrollment values (e.g., via communication port 520).

The programs 512, 514 may be stored in a compressed, uncompiled and/or encrypted format. The programs 512, 514 may furthermore include other program elements, such as an operating system, a database management system, and/or device drivers used by the processor 510 to interface with peripheral devices.

As used herein, information may be “received” by or “transmitted” to, for example: (i) the scenario analytics apparatus 500 from another device; or (ii) a software application or module within the scenario analytics apparatus 500 from another software application, module, or any other source.

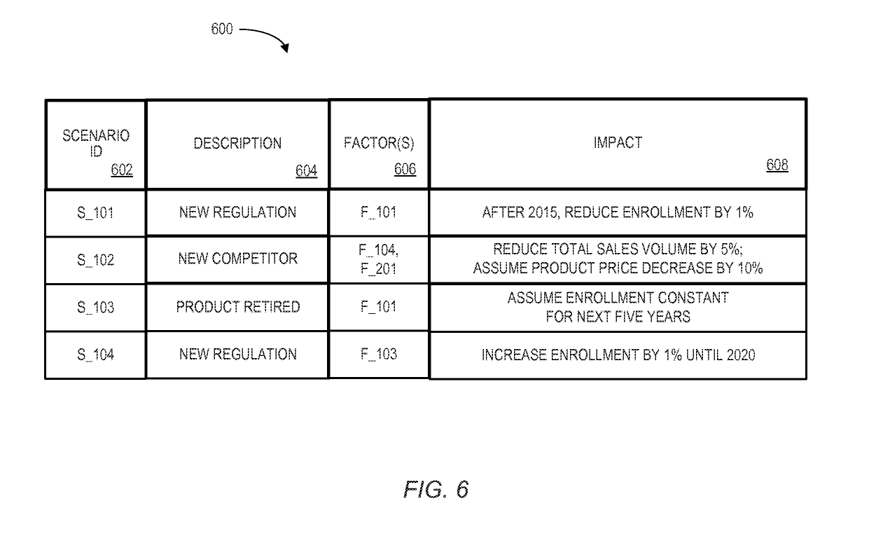

In some embodiments (such as shown in FIG. 5), the storage device 530 stores historical data 550, a scenario impact database 600, and impacted selected metric data 600. An example of a database that may be used in connection with the scenario analytics apparatus 500 will now be described in detail with respect to FIG. 6. Note that the database described herein is only one example, and additional and/or different information may be stored therein. Moreover, various databases might be split or combined in accordance with any of the embodiments described herein.

Referring to FIG. 6, a table is shown that represents the scenario impact database 600 that may be stored at the scenario analytics apparatus 500 according to some embodiments. The table may include, for example, entries identifying future actions (e.g., statutory changes, new products entering the marketplace, etc.). The table may also define fields 602, 604, 606, 608 for each of the entries. The fields 602, 604, 606, 608 may, according to some embodiments, specify: a scenario identifier 602, a description 604, factors 606, and impacts 608. The information in the scenario database 600 may be created and updated, for example, based on information received from a stakeholder or business analyst.

The scenario identifier 602 may be, for example, a unique alphanumeric code identifying an action or situation that might develop in the future and the description 604 may describe that scenario (e.g., as being a “new regulation”). The factors 606 may indicate which underlying factors are expected that impacted by that scenario and the impact 608 may be defined in the scenario impact database. For example, scenario “S_102” is associated with a new competitor entering the marketplace. It is expected that relevant underlying factor “F_104” will reflect reduced sales value by 5% and underlying factor “F_201” will experience a 10% product price decrease as a result of the new product entering the marketplace. The information in the scenario impact database 600 may be used to adjust the factors 606 to take the impact 608 into account and the resulting impacted values may be re-fed through a predictive model to determine the ultimate impact on a select metric as a result of the scenario.

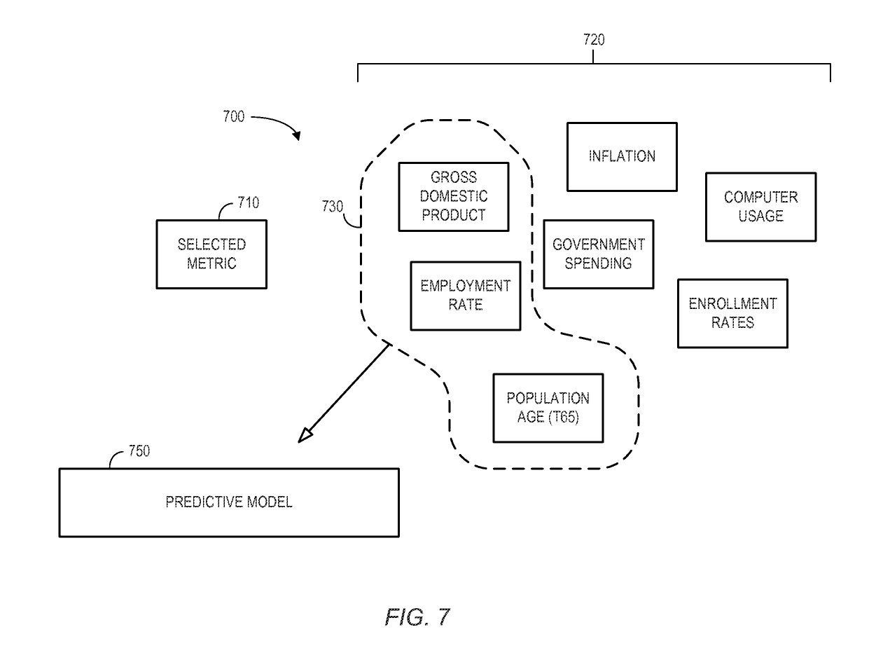

FIG. 7 is an illustration 700 associated with a predictive model according to some embodiments. In particular, once a selected metric 710 is determined, a pool of potentially relevant underlying factors 720 may be automatically evaluated. For example, if an enterprise determines that an insurance program enrollment rate is the selected metric 710, hundreds of potentially relevant underlying factors 720 may be evaluated to identify a sub-set of those as being relevant underlying factors 730. In the example of FIG. 7, gross domestic product, employment rate and population age (when people will turn 65 years old) have been identified as being relevant underlying factors 730 for the selected metric 710. That is, it might be determined that a change in population age has a large effect on insurance program enrollment while changes in computer usage has little or no effect (and thus population age is an appropriate relevant underlying factor 730 for that selected metric 710 and computer usage is not). The relevant underlying factors 730 may be used as the basis for a predictive model 750 that will output appropriate predicted future values for the selected metric 710 based on input relevant underlying factor 730 values.

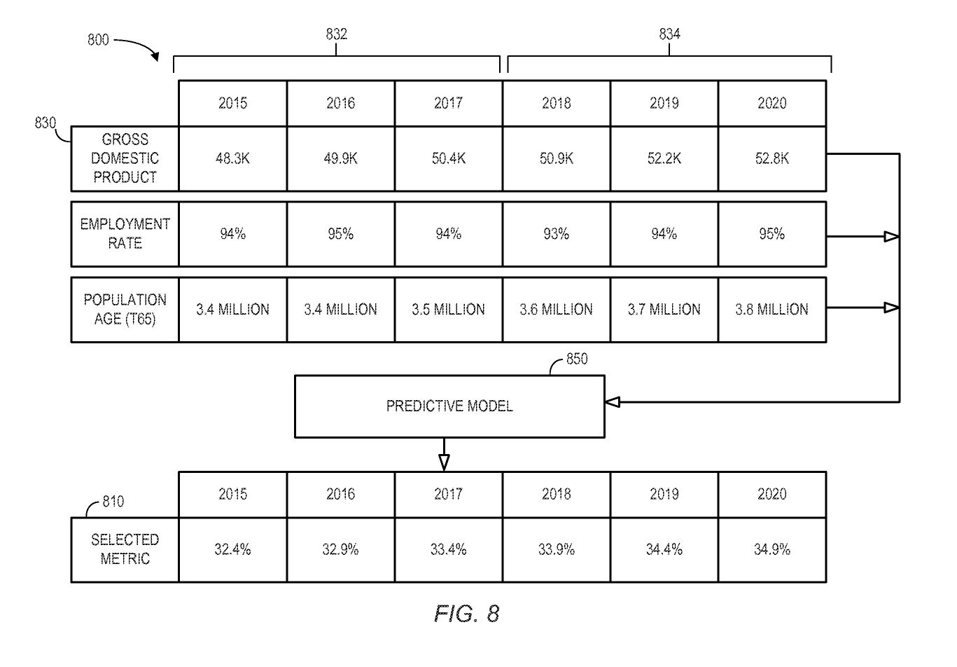

FIG. 8 is an illustration 800 associated with such predicted future values for a selected metric 810 in accordance with some embodiments. In particular, values for the relevant underlying factors 830 may include historic values 832 and predicted future values 834. Note that in the example of FIG. 8, may be assumed that the illustration 800 was rendered at the end of the year 2017, and the gross domestic product (e.g., on a per-capita basis) of “50.4K” may represent an actual historic value for the year 2017 while “50.9K” is a predicted future value for the year 2018. The three relevant factors 830 are fed into a predictive model 850 which outputs predicted values for the selected metric 810 based on those inputs. In the example of FIG. 8, the predictive model indicates that the selected metric 810 will have a value of 34.9% in the year 2020.

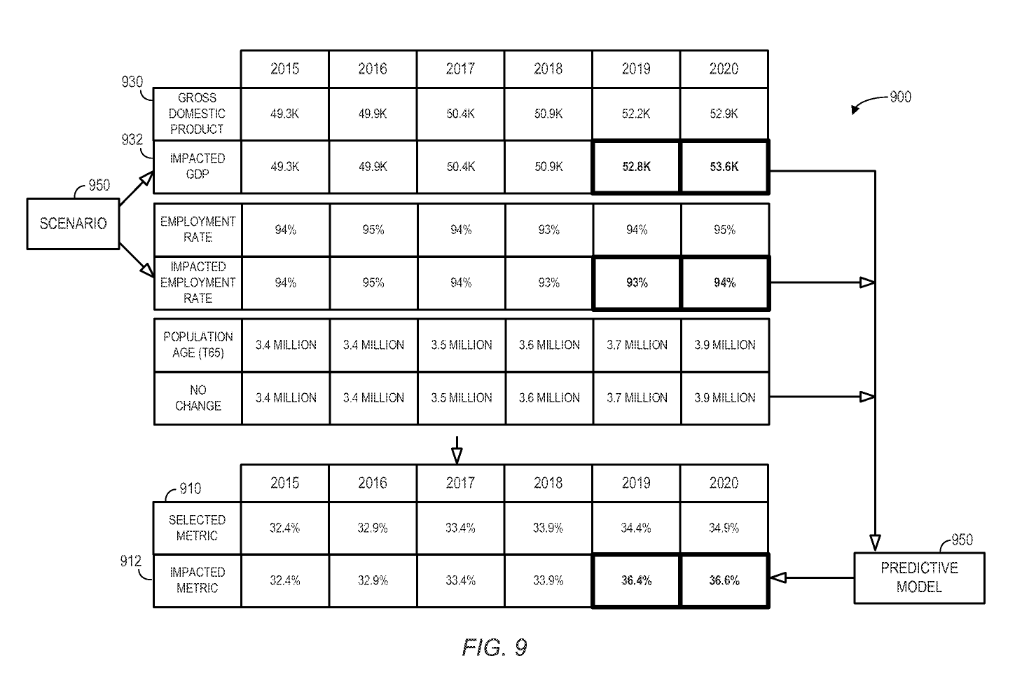

FIG. 9 is an illustration 900 associated with a scenario's impact according to some embodiments. As in FIG. 8, values for the relevant underlying factors 930 may include historic values and predicted future values. The three relevant factors 930 were previously fed into a predictive model 950 which output predicted values for the selected metric 910 based on those inputs. In the example of FIG. 9, the predictive model indicates that the selected metric 910 will have a value of 34.9% in the year 2020. In this embodiment, a scenario 950 is defined. In particular, the scenario 950 impacts one or more relevant underlying factors 930. In the example of FIG. 9, the scenario 950 impacts gross domestic product and employment rate but does not impact population. The results of these impacts are applied to created impacted values 932. For example, as a result of the scenario 950 the value of gross domestic product in the year 2020 is now expected to be “53.6K” (instead of “52.9K” without the scenario 950). The impacted values 932 may be input into the predictive model 950 which in turn may output impacted values 912 for the selected metric 910. In the illustration 900 of FIG. 9, the impacted metric value 912 in the year 2020 is “36.6%” as a result of the scenario 950 (as compared to the non-impacted value of “34.9%” if the scenario 950 does not occur). The impacted values 912 may then be used by an enterprise to make strategic business decisions.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

Applicants have discovered that embodiments described herein may be particularly useful in connection with insurance metrics. Note, however, that other types of interactions may also benefit from the invention. For example, embodiments of the present invention may be used in connection with governmental departments and the financial, education, and medical industries. Note that any of the embodiments described herein might be associated with any type of selected metric (in addition to insurance related metrics).

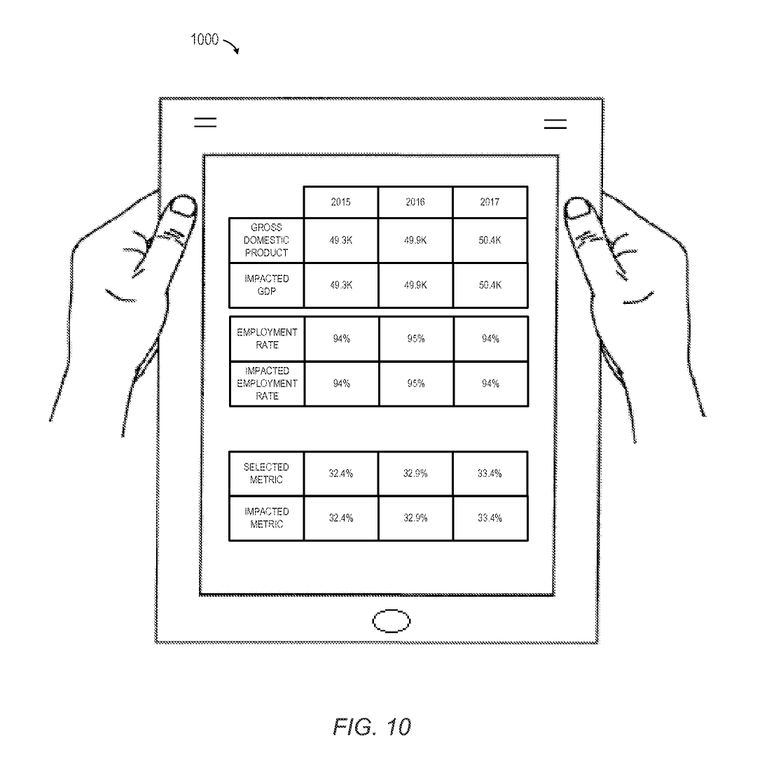

Moreover, some embodiments have been described herein as being accessed via a PC or laptop computer. Note, however, that embodiments may be implemented using any device capable of executing the disclosed functions and steps. For example, FIG. 10 illustrates a display 1000 in accordance with some embodiments described herein. In particular, the display includes a graphical user interface including information about the expect impact of a scenario on a selected metric.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system associated with a future scenario's impact on future values for a selected insurance related metric, comprising:
a communication device to receive an indication of a selected insurance related metric to be predicted;
a computer processor for executing program instructions; and
a memory, coupled to the computer processor, for storing program instructions for execution by the computer processor to:
analyze historical information for a set of potential underlying factors to automatically determine a set of relevant underlying factors associated with the selected insurance related metric,
create a predictive model based on relationships between values of the set of relevant underlying factors and values of the selected insurance related metric,
identify a series of predicted future values for each relevant underlying factor,
predict a series of future values for the selected metric based on the series of predicted future values for each relevant underlying factor and the predictive model,
define a future scenario associated with an impact on at least one of the relevant underlying factors,
identify a series of predicted impacted future values for each impacted relevant underlying factor associated with the future scenario,
predict a series of impacted future values for the selected insurance related metric based on the series of predicted impacted future values for each impacted relevant underlying factor and the predictive model, and
transmit an indication of the series of impacted future values for the selected insurance related metric.

2. The system of claim 1, wherein the selected insurance related metric is associated with at least one of: (i) sales, (ii) profit, (iii) prices, (iv) participation percentages, (v) call center volume, (vi) a business result, and (vii) market share.

3. The system of claim 1, wherein at least one potential underlying factor is associated with: (i) population age information, (ii) gross domestic product, (iii) enrollment rates, (iv) market share, (v) inflation, (vi) employment rates, and (vii) a macroeconomic trend.

4. The system of claim 1, wherein the predictive model is associated with at least one of: (i) a statistical model, (ii) a multi-variable regression model, (iii) a neural network, (iv) a Bayesian network, (v) a hidden Markov model, (vi) an expert system, (vii) a decision tree, and (viii) a support vector machine.

5. The system of claim 1, wherein said identification of predicted future values for each relevant underlying factor is associated with at least one of: (i) a third party service, (ii) census data, (iii) governmental projections, and (iv) an underlying factor model.

6. The system of claim 1, wherein the future scenario is associated with at least one of: (i) a regulatory or statutory change, (ii) an enterprise entering a marketplace, (iii) an enterprise exiting a marketplace, and (iv) an introduction of a new product.

7. The system of claim 1, wherein the transmitted indication of the series of impacted future values is associated with at least one of: (i) a delta change associated with the scenario, (ii) a report, and (iii) a strategic recommendation.

8. The system of claim 1, wherein execution of the stored program instructions by the processor is further to:
compare impacted future values for the selected insurance related metric value associated with a first future scenario with impacted future values for the selected insurance related metric value associated with a second future scenario.

9. A computer-implemented method associated with a future scenario's impact on future insurance plan enrollment values, comprising:
automatically analyzing, by a modeling engine executed by a computer processor, historical information for a set of potential underlying factors to determine a set of relevant underlying factors associated with insurance plan enrollment;
creating, by the modeling engine, a predictive model based on relationships between values of the set of relevant underlying factors and insurance plan enrollment values;
identifying a series of predicted future values for each relevant underlying factor;
defining a future scenario associated with an impact on at least one of the relevant underlying factors;
identifying a series of predicted impacted future values for each impacted relevant underlying factor associated with the future scenario;
predicting a series of impacted future insurance plan enrollment values based on the series of predicted impacted future values for each impacted relevant underlying factor and the predictive model; and
transmitting an indication of the series of impacted future insurance plan enrollment values.

10. The method of claim 9, wherein at least one potential underlying factor is associated with: (i) population age information, (ii) gross domestic product, (iii) enrollment rates, (iv) market share, (v) inflation, (vi) employment rates, and (vii) a macroeconomic trend.

11. The method of claim 9, wherein the predictive model is associated with at least one of: (i) a statistical model, (ii) a multi-variable regression model, (iii) a neural network, (iv) a Bayesian network, (v) a hidden Markov model, (vi) an expert system, (vii) a decision tree, and (viii) a support vector machine.

12. The method of claim 9, wherein said identification of predicted future values for each relevant underlying factor is associated with at least one of: (i) a third party service, (ii) census data, (iii) governmental projections, and (iv) an underlying factor model.

13. The method of claim 9, wherein the future scenario is associated with at least one of: (i) a regulatory or statutory change, (ii) an enterprise entering a marketplace, (iii) an enterprise exiting a marketplace, and (iv) an introduction of a new product.

14. The method of claim 9, wherein the transmitted indication of the series of impacted future values is associated with at least one of: (i) a delta change associated with the scenario, (ii) a report, and (iii) a strategic recommendation.

15. The method of claim 9, further comprising:
comparing impacted future values for the selected metric value associated with a first future scenario with impacted future values for the selected metric value associated with a second future scenario.

16. A non-transitory computer-readable medium storing instructions adapted to be executed by a computer processor to perform a method associated with a future scenario's impact on future insurance plan enrollment values, said method comprising:
automatically analyzing historical information for a set of potential underlying factors to determine a set of relevant underlying factors associated with insurance plan enrollment;
creating a predictive model based on relationships between values of the set of relevant underlying factors and insurance plan enrollment values;
identifying a series of predicted future values for each relevant underlying factor;
defining a future scenario associated with an impact on at least one of the relevant underlying factors;
identifying a series of predicted impacted future values for each impacted relevant underlying factor associated with the future scenario;
predicting a series of impacted future insurance plan enrollment values based on the series of predicted impacted future values for each impacted relevant underlying factor and the predictive model; and
transmitting an indication of the series of impacted future insurance plan enrollment values.

17. The medium of claim 16, wherein at least one potential underlying factor is associated with: (i) population age information, (ii) gross domestic product, (iii) enrollment rates, (iv) market share, (v) inflation, (vi) employment rates, and (vii) a macroeconomic trend.

18. The medium of claim 16, wherein the predictive model is associated with at least one of: (i) a statistical model, (ii) a multi-variable regression model, (iii) a neural network, (iv) a Bayesian network, (v) a hidden Markov model, (vi) an expert system, (vii) a decision tree, and (viii) a support vector machine.

19. The medium of claim 16, wherein said identification of predicted future values for each relevant underlying factor is associated with at least one of: (i) a third party service, (ii) census data, (iii) governmental projections, and (iv) an underlying factor model.

20. The medium of claim 16, wherein the future scenario is associated with at least one of: (i) a regulatory or statutory change, (ii) an enterprise entering a marketplace, (iii) an enterprise exiting a marketplace, and (iv) an introduction of a new product.

21. The medium of claim 16, wherein the transmitted indication of the series of impacted future values is associated with at least one of: (i) a delta change associated with the scenario, (ii) a report, and (iii) a strategic recommendation.
